(19) United States
(12) Patent Application Publication
(10) Pub. No.: US 2001/0032193 A1
(43) Pub. Date: Oct. 18, 2001

(54) System and method for transmission of advertising to wireless devices

(76) Inventor: John B. Ferber, Baltimore, MD (US)

Correspondence Address: FINNEGAN, HENDERSON, FARABOW,, GARRETT & DUNNER, L.L.P., 1300 I Street, N.W., Washington, DC, 20005, US

(21) Appl. No.: 09/753,685

(22) Filed: Jan. 4, 2001

Related U.S. Application Data
(60) Provisional application No. 60/174,498, filed on Jan. 4, 2000.

(51) Int. Cl. G06F 17/60; H04K 1/00; H04L 9/00

(52) U.S. Cl. 705/79; 705/14

(57) ABSTRACT

The present invention discloses a system and methods for wireless device advertising. The system comprises a database of wireless device numbers for storing users of registered wireless devices and a central processing unit accessible by a network. Once the system receives an advertising message from an advertiser over the network, it forwards the advertising message wirelessly to the registered devices. The user of the wireless device is then remunerated for accepting the advertising message.

### RELATED APPLICATIONS

This application claims priority in U.S. Provisional Patent Application No. 60/174,498 entitled System and Method for Transmission of Advertising to Wireless Devices filed Jan. 4, 2000.

### FIELD OF THE INVENTION

The present invention relates generally to the field of wireless communications, and more particularly to a system and method for sending advertising messages to wireless devices.

### BACKGROUND OF THE INVENTION

According to the Cellular Telecommunications Industry Association, wireless service subscribers in the United States totaled approximately 100 million, or 36 percent of the population, as of July 2000. And each day about 67,000 new users subscribe to wireless services.

Wireless devices such as cellular telephones and modem equipped personal digital assistants (PDAs), like any other medium, can be used by advertisers to reach consumers with their marketing messages. One problem with advertising to wireless devices is that some people may not want to receive the advertising messages on their cellular telephone or PDAs. Since cellular telephones, for example, have not traditionally been used by the advertising community, some users of cellular telephone may be reluctant to accept advertising on their devices. Another problem is that air time on these devices is metered. For example, if air time is metered whether a user is sending or receiving a communication, advertising that might be provided to a cellular telephone user could potentially cost that cellular telephone user additional money for receiving such advertising.

The present invention seeks to overcome that disadvantage by remunerating users for wireless device usage in exchange for allowing advertisers to send marketing messages directly to the wireless device.

### SUMMARY OF THE INVENTION

Accordingly, the present invention is directed to a method and system for providing advertising to wireless devices with the user of the wireless device being remunerated to accept the advertising on their wireless devices that substantially obviates one or more of the problems due to limitations and disadvantages of the related art.

In accordance with the purposes of the present invention, as embodied and broadly described, the invention provides a method for wireless device advertising. Users of wireless devices are provided a means to register their wireless devices to receive advertising messages. To register, users must provide at least a wireless device number which is stored in a first database. After advertising messages are received from the advertiser, they are sent to registered wireless devices. Advertisers pay a fee for having the advertising messages sent to the wireless devices. A portion of that fee is remunerated to the users for accepting the advertising messages to their registered wireless devices.

In another embodiment, the invention provides a system for wireless device advertising including at least one database comprising users of registered wireless devices including wireless device numbers. The system further includes a central processing unit accessible by a network that receives an advertising message from an advertiser. The central processing unit sends the advertising message to at least one of the registered wireless devices wherein the user is remunerated for accepting the advertising message.

In another embodiment of the present invention, a method of using a computer network for wireless device advertising is provided. Accordingly, a first database containing a plurality of users of registered wireless devices and wireless device numbers is stored in a memory location accessible by a computer network. Once advertising messages are received from an advertiser over the computer network, they are sent to at least one of the wireless device numbers in the database. The user of the wireless device is then remunerated for accepting the advertising message.

In still another embodiment, the present invention provides a method for wireless device advertising wherein advertisers provide advertising messages to an entity administering a wireless advertising service. The service then forwards the messages to users of registered wireless devices. The advertisers pay a fee to the entity administering the wireless advertising service, a portion of that fee going to the user for accepting the advertising messages.

In another embodiment, the present invention provides a method for wireless device advertising wherein advertisers send advertising messages to a registered wireless device and provide remuneration to a user of the wireless device for accepting the advertising messages.

Additional objects and advantages of the invention will be set forth in part in the description which follows, and in part will be clear from the description, or may be learned by practice of the invention. The objects and advantages of the invention will be realized and attained by means of elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate an embodiment of the invention and, together with the description, serve to explain the objects, advantages, and principles of the invention.

FIG. 1 is a flow chart illustrating the method for wireless device advertising;

FIG. 2 is a flow chart illustrating the method for wireless device advertising where users of registered wireless devices can earn payment for referring another wireless device user to register to receive advertising messages;

FIGS. 3 illustrates a system for wireless device advertising; and

FIG. 4 illustrates a method for advertisers to send advertising messages to users of wireless devices who opt to receive them using a wireless advertising service.

FIG. 5 illustrates a method for advertisers to send advertising messages to users of wireless devices who opt to receive them.

### DETAILED DESCRIPTION OF THE PREFERRED EMBODIMENTS

In the following detailed description of the embodiments of the present invention, reference is made to the accompanying drawings that form a part thereof, and in which is shown by way of illustration a specific embodiment in which the invention may be practiced. This embodiment is described in sufficient detail to enable those skilled in the art to practice the invention and it is to be understood that other embodiments may be utilized and that structural changes may be made without departing from the scope of the present invention. The following detailed description is, therefore, not to be taken in a limited sense.

In general terms, the present invention is directed to a method for wireless device advertising in which a user of a cellular telephone, for example, registers on a website. That registration provides the website with the cellular telephone number of the user. Once registered, the user will begin to receive advertising messages sent from advertisers who have signed up with the present invention. The advertising messages can be sent in many ways such as, for example, text or voice messages. Users receive remuneration per message sent to the registered wireless device thereby allowing the customer to earn additional “free” air time on the wireless device. In this fashion, both the advertiser and the customer win since the advertising can be placed over yet another media to a customer, and the customer can earn additional free cellular device time by virtue of accepting such advertisement.

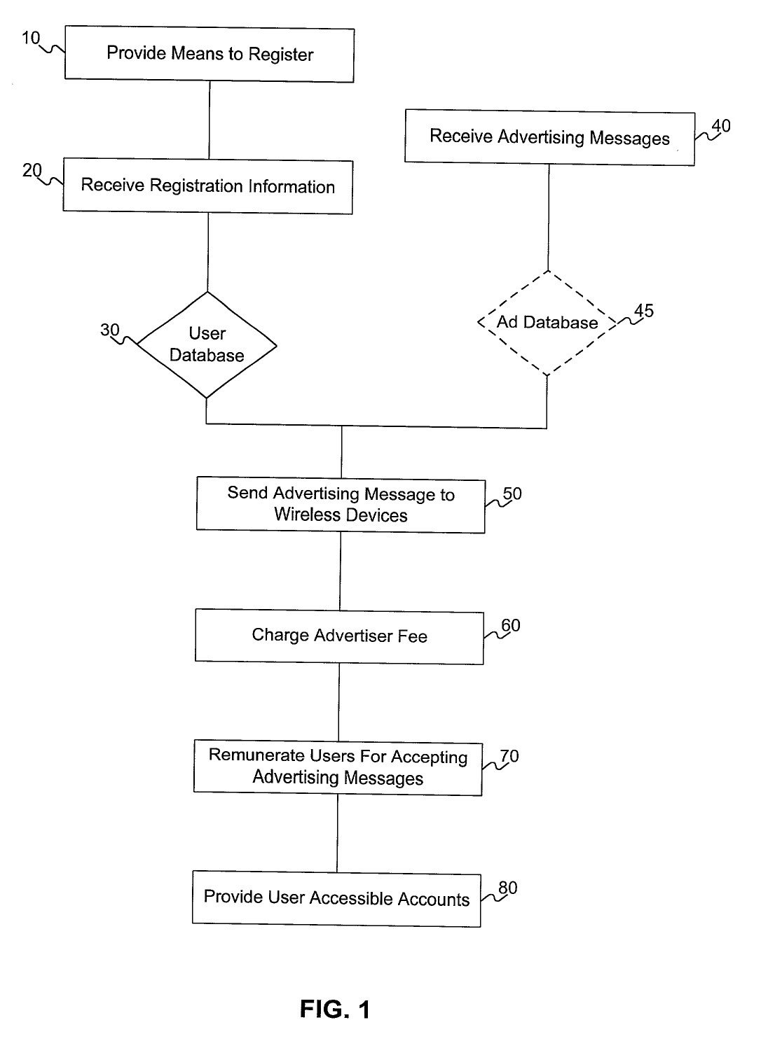

Referring to FIG. 1, the overall process for wireless device advertising wherein users of registered wireless devices receive remuneration for accepting advertising on their wireless devices is shown in flow diagram form. As shown in step 10, wireless device users register their wireless devices to receive advertising messages. As used herein, the term “wireless devices” means simple pagers that alert a user of an incoming message typically with the incoming callers telephone number, personal digital assistants (PDAs) equipped with modems and enhanced pagers with information transmission and retrieval capabilities, cellular telephones operating on one or more of an analog and/or digital (for example, CDMA, TDMA, GSM, PCS, cdma2000, GPRS, HSCSD, EDGE, W-CDMA or UMTS) systems, wireless e-mail devices (for example, BlackBerry devices), or any other handheld device capable of accessing a network over a wireless communications medium.

Registration can be accomplished by any method that provides the user's registration information to the entity administering the wireless device advertising service. These methods include, but are not limited to, a website that allows users to input information online that is sent to the administering service via the Internet, a telephone system that allows users to input information via the telephone keypad or to an individual operator, an email address that accepts the information via email, and a form that can be mailed via a mail service such as the U.S. Postal Service or Federal Express. The entity administering the wireless device advertising service can also register users through, for example, telephone solicitation. Registration can also be accomplished at the time of signing a contract for wireless service, such as for example, when a user is signing up for cellular telephone service with a particular cellular service provider. Thus, the user is typically the owner of the wireless device and under contract to a wireless service provider.

In step 20, the entity administering or managing the wireless advertising service receives registration information from users wishing to receive advertising on their wireless devices. The registration information should include, at a minimum, the name of the wireless device user and the wireless device number. As used herein, the term wireless device number” means the number that allows transmission to the wireless device, such as for example the telephone number of a cellular telephone, the pager number that must be dialed to send a page, or the e-mail address to send a message to an email account accessible by, for example a BlackBerry device, a text capable pager, a cellular telephone, or a modem equipped PDA.

The registration information can also include demographic information of the user. This includes, but is not limited to sex, age, address, marital status, income, occupation, educational level, wireless device type and service provider, times most willing to receive advertising, and hobbies and/or interests. The advertisers or the advertising service can use this information for targeted ad campaigns to send advertising messages that are appropriate or of specific interest to the user of a registered wireless device. Registration information is stored in user database 30.

As shown in step 40, advertisers send advertising messages promoting their products or services to the entity administering the wireless device advertising service. As used herein, the term “advertising message” means any promotional information, coupons or offers that provide a discount or rebate to the purchaser of a specific product or service including time-sensitive coupons, information on a specific product, sales alerts and interactive branching advertisements. The advertising messages from the advertisers can be sent to the entity administering the service in any format including, but not limited to, voice, electronic, or print copy. In step 50, the entity administering the wireless advertising service sends the advertising messages to the registered wireless devices. If necessary, the format of the advertising messages can be modified so that the messages conform to specific cellular company's specifications or wireless device limitations. An advertising message sent by an advertiser to the administering service may need to be re-formated by the administering service for registered users of, for example, AT&T Wireless service which allows text messages up to 110 characters. The type of message can also be changed by the administering service to allow transmission to a variety of wireless devices. For example, if advertising messages are sent to the entity administering the service as e-mail, the administering service can send the email advertising messages to registered wireless devices capable of receiving e-mail. For registered devices not capable of receiving e-mail, the administering service can re-format the email advertising messages into the appropriate format such as voice for certain cellular telephones, text for pagers, or text and graphics for web enabled cellular telephones and PDAs. The advertising messages can also be re-formated into specific protocols for wireless devices such as for example, Wireless Application Protocol (WAP), Short Message Service (SMS), XML/MML, or i-Mode. The advertising messages can be stored in an optional database 45 shown in FIG. 1.

The entity administering the service charges the advertisers a fee for sending the advertising messages to the registered wireless devices as shown in step 60. The entity administering the service remunerates a portion of that fee to the user of the registered wireless device for accepting the advertising messages as shown in step 70. The entity administering the service can remunerate registered users after that user has accepted, for example, a predetermined number of advertising messages or a predetermined volume (bytes), or a predetermined amount of air time.

As used herein, the term “accepting the advertising message” means that the wireless device receives the sent or transmitted text, voice, or other format message.

As used herein the term “remuneration” means compensation, in any form, given to a user for accepting advertising messages on a registered wireless device. Thus, remuneration is not limited to monetary compensation and can be, for example, additional air time for the registered wireless device, points in a bonus program redeemable for products or services, entries in a sweepstakes, or any other compensation a user of a wireless device would accept in exchange for receiving advertising messages on the user's wireless device.

Wireless device users typically pay a monthly fee for a fixed number of air time minutes. By allowing a registered user to earn remuneration for accepting the advertising messages, both the advertiser and the user win since the advertising can be placed over yet another media to a user, and the user can earn remuneration, such as for example, additional “free” wireless device air time by virtue of accepting such advertisement. For wireless device users that pay a monthly or yearly fee for unlimited air time minutes, remuneration in the form of monetary payments, for example, can help defer the cost of the monthly or yearly fees. It should be noted that the entity administering the wireless advertising service is not limited by when it charges the advertisers. It can do so either before or after the advertising messages have been sent to the users. It is also not necessary for the advertiser or the administering service to identify a specific portion of the fee that will be paid to the registered users.

Sending advertising messages to registered users may incur air time costs to the user. In an embodiment of the present invention, a portion of such air time costs are paid for by the advertiser. As discussed above, advertisers typically pay a fee to the entity administrating the wireless advertising service. A portion of this fee can be used by the administering service to pay at least a portion of the air time costs for sending the advertising messages. Advertisers can also pay a separated fee to the administering service to defray the registered user's air time costs. This payment can be made directly to the wireless access company such as for example Sprint, AT&T, or Cellular One, or to the user of the registered wireless device as reimbursement for air time costs.

The method of the present invention can further include providing an account for each user of a registered wireless device (step 80). The account can be, for example, Internet accessible, so that the user of the registered wireless device can check how much remuneration he or she has earned by accepting advertising messages or referring new users.

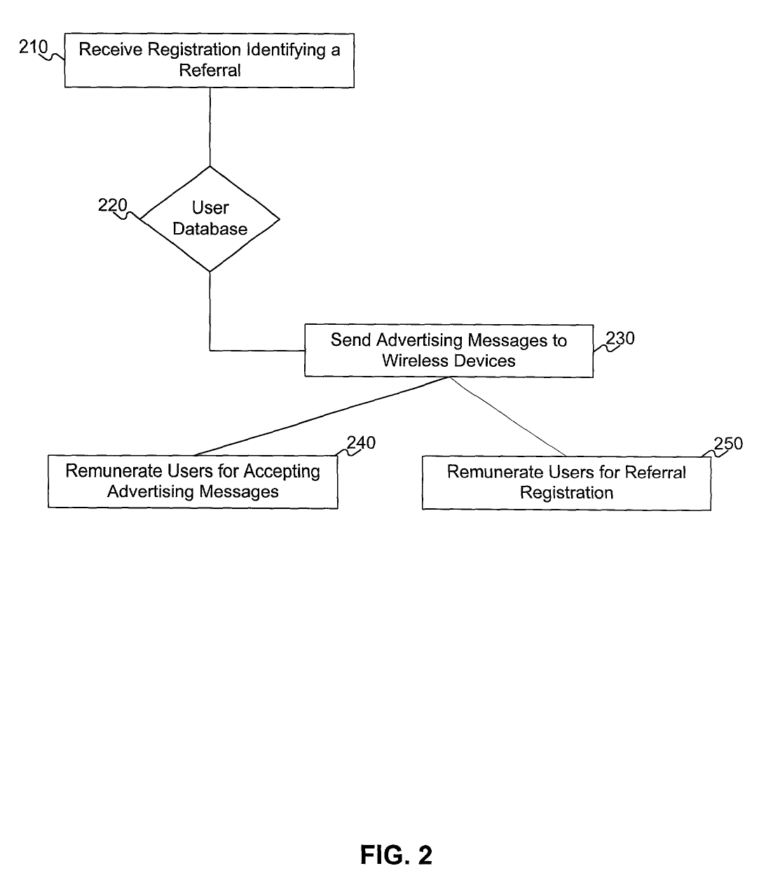

Referring to FIG. 2, users of registered wireless devices can earn remuneration for referring another wireless device user to register to receive advertising messages. After the administering service receives registration information from a new user identifying an existing registered user as a referring user (step 210), that information is stored in database 220. Once the new user accepts advertising messages that are sent (step 230), the referring user then receives remuneration for referring the new user (step 250). As used herein, the term “referral” means that a new, unregistered wireless device user registers to receive advertising messages and identifies, during registration, a previously registered user as the party informing or causing the unregistered user to register. The meaning of the term “referral” further includes when a registered user identifies to the entity administering the wireless device advertising service a new, unregistered user and that new, unregistered user subsequently registers.

The referring user also receives remuneration for accepting advertising messages at his or her registered wireless device as shown in step 240. A portion of the remuneration received by the user shown in step 240 can also be to defray at least a portion of the air time costs for receiving the advertising messages.

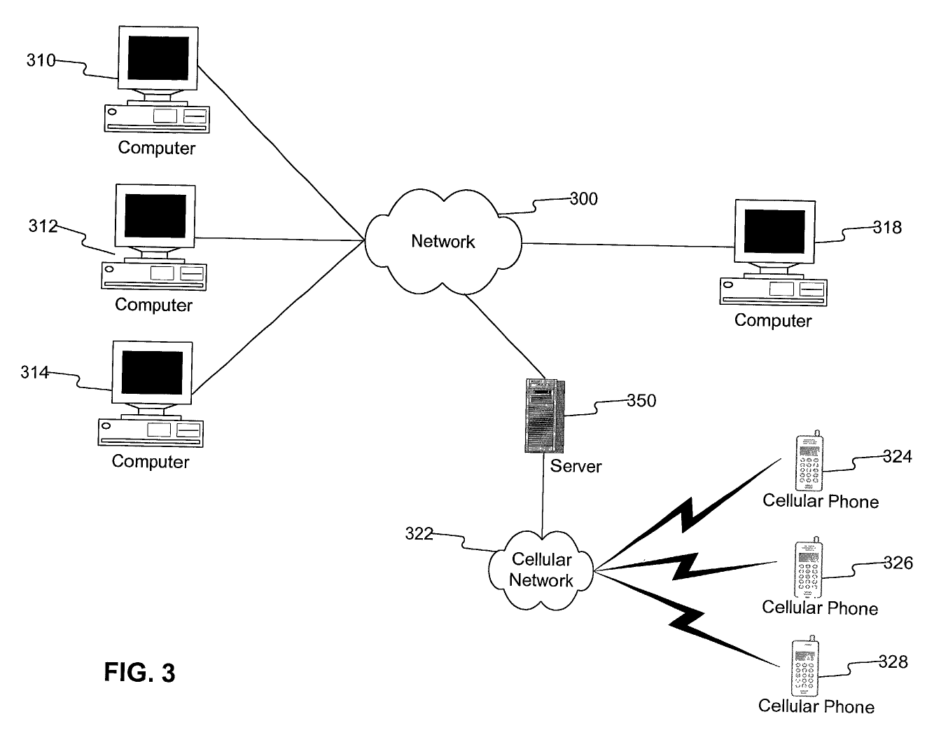

In another embodiment, the present invention includes a system for wireless device advertising. Referring to FIG. 3, wireless device owners access network 300 and log onto the website of the present invention using personal computers 310, 312, 314. Alternatively, a user of the wireless device can also directly contact the entity that runs server 350 of the present invention. In any case, registration with the entity that is administering the server of the present invention can be by any means that will reasonably allow such registration to take place. Thus, personal computers over a network can be one means, normal telephony wherein information is input to the server is yet another means, or the user can simply register with the server using a registration form mailed via the U.S. Postal Service.

Referring again to FIG. 3, users register over network 300 which is preferably the Internet although this is not meant as a limitation. As noted above, the network could be a cellular network wherein the user simply uses a cellular device to register with the server the present invention. The user then registers his or her name and the wireless device number or access number with server 350 of the present invention. Server 350 stores the user names and associated wireless device numbers in a database. Advertisers then provide appropriate advertisement from their computers 318 to server 350 of the present invention. The advertising messages can be stored in another database on server 350.

Server 350 of the present invention then sends the digital advertising over digital or cellular network 322 where it arrives in a wireless fashion to wireless devices 324, 326, and 328, registered with the entity sponsoring the server or administering the wireless device advertising service of the present invention. Although depicted as cellular telephones, wireless devices 324, 326, and 328 can be any wireless device.

As noted above, users of wireless devices 324, 326, and 328 receive remuneration for accepting the advertising messages. Furthermore, a portion of the air time that is used to send advertising messages to wireless device owners can be paid for by the source of the advertising messages. When advertising messages are sent to the user via the wireless advertising service, the service can charge fees to advertisers 318 and thereby recoup the cost of not only a portion the air time for representing the digital advertising but the remuneration that is given to users 324, 326, and 328 in exchange for accepting advertising

Server 350 further includes accounts for each registered wireless device. As discussed above, the account can be, for example, Internet accessible, so that the user of the registered wireless device can check how much additional air time he or she has earned by accepting advertising messages or referring new users.

Server 350 can further include a referral means for a registered user to send a message to a new user informing the new user about accepting wireless device advertising. The means can be, for example, a web page that allows the registered user to input the name and wireless device number of a new user, as well as a message. Once the new user registers to receive advertising messages, the referring registered user can receive payment for referring the new user.

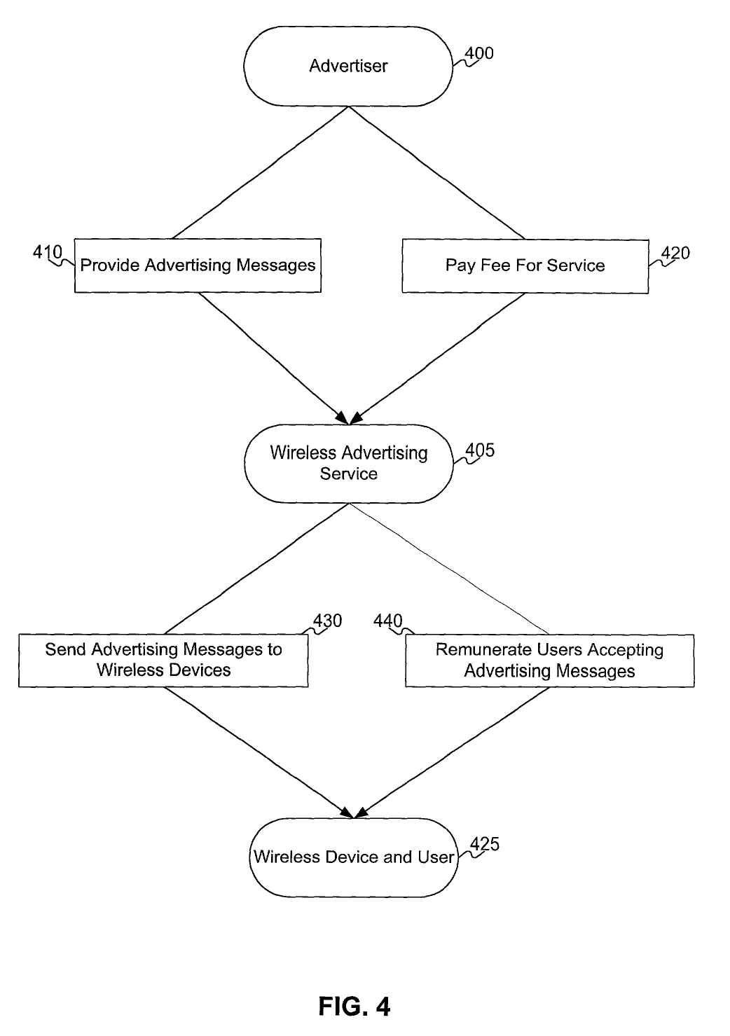

Another embodiment of the present invention is a method for advertisers, such as for example, companies selling products and/or services, to utilize an intermediary (e.g., wireless advertising service) to advertise, thereby providing a seamless, response-oriented advertising message to users who opt-in or register to receive those advertising messages. FIG. 4 shows the flow of advertisements and payment/renumeration from advertiser 400 to advertising service 405 to wireless device 425.

In step 410, advertisers 400 provide an advertisement to an entity administrating a wireless device advertising service 405. Wireless device advertising service 405 sends the advertising messages to registered wireless device 425 in step 430. Since users opt to receive the advertising messages by registering, advertisers can target potential customers with the right products or information at the right time and the right place. This also allows users of wireless devices to receive advertising messages that they want.

Location-based advertising is one example. Using wireless location technology that tracks the location of wireless devices, a sporting goods store, for example, can send an advertising message to let a golfer walking into a mail know that they're having a sale on golf balls. Furthermore, the advertising message could include a coupon for an additional discount. Users of wireless devices living in San Francisco, for example could opt to receive advertising for restaurants and night clubs located in the San Francisco Bay area. Other types of advertising messages could include entertainment tips or coupons that the user could show to a merchant.

Advertisers 400 pay a fee to wireless advertising service 405 as shown in step 420. And, as shown in step 440, a portion of the fee goes to wireless device user 425 for accepting the advertising messages. In this manner, the advertisers get access to potential customers who want their advertising messages and the wireless device users or potential customers get remuneration for accepting the advertising messages.

The remuneration can also include payment or compensation for a portion of the air time required to send the advertising messages. The payment or compensation can be paid for by the entity administering the service or the advertiser directly to the wireless service provider or to the user in the form of a reimbursement.

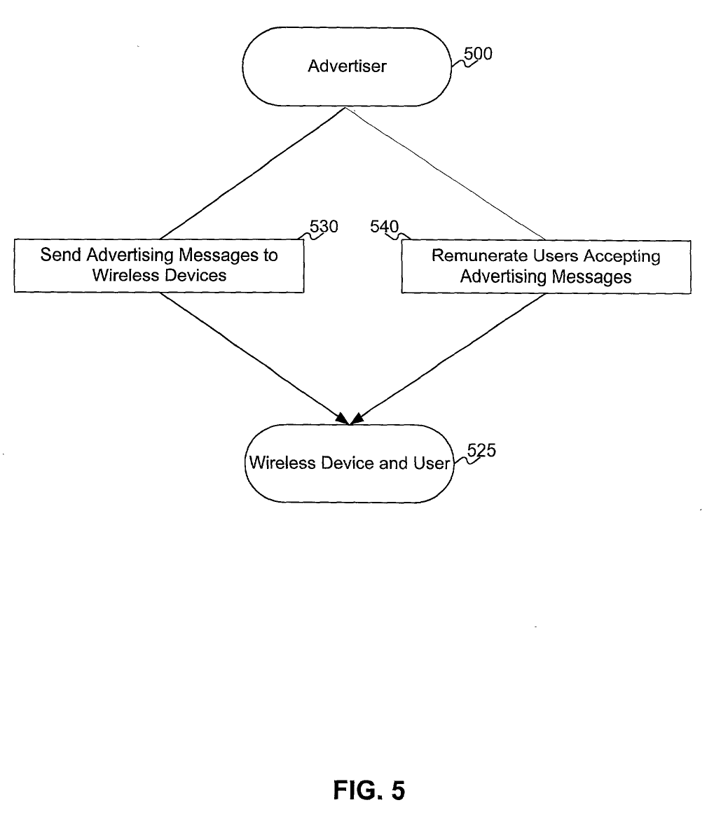

In another embodiment shown in FIG. 5, a method for advertisers to send advertising messages directly to the user of a registered wireless device is shown. This method is similar to the embodiment illustrated in FIG. 4, except an administrating service is not used. Instead, as shown in step 530, advertiser 500 sends an advertising message to registered wireless device 525. Advertiser 500 also remunerates the user of wireless device 525 for accepting the advertising message as shown in step 540. As discussed above, registration of the wireless device can be by any method that allows the user of a wireless device to opt to receive the advertising messages and that provides the advertiser with the registration information. And, as also previously discussed, the remuneration is not limited to monetary compensation or air time, but can be in any form.

A system, method, and business model representing advertisement over cellular and digital networks has now been shown. It will be apparent to those skilled in the art that other information can be transmitted to wireless device users in a similar fashion, that is, by paying not only for the air time but also by remunerating additional “free” time for wireless device users without departing from the scope of the invention as disclosed.

It will be apparent to those skilled in the art that various modifications and variations can be made in the disclosed method, system, and business model for wireless device advertising. Thus, it is intended that the present invention cover the modifications and variations of this invention provided they come within the scope of the appended claims and their equivalents.

What is claimed is:

1. A method of wireless device advertising comprising:
registering a wireless device to receive advertising messages;
receiving registration information including at least a wireless device number and storing said information in a database;
receiving advertising messages from advertisers;
sending the advertising messages to a registered wireless device; and
remunerating users for accepting the advertising messages to their registered wireless devices.

2. The method of claim 1 further comprising receiving payment from the advertisers for sending the advertising messages.

3. The method of claim 1 wherein users are remunerated points as part of a bonus program for accepting the advertising messages.

4. The method of claim 1 wherein users are remunerated additional air time for accepting the advertising messages.

5. The method of claim 1 wherein users are remunerated monetary compensation for accepting the advertising messages.

6. The method of claim I wherein users receive remuneration for referring an unregistered user to register a wireless device to receive advertising messages.

7. The method of claim 1 further including providing a user accessible account for each registered wireless device showing the amount of remuneration accrued for accepting advertising messages.

8. The method of claim 1, wherein registering the wireless devices to receive advertising messages includes providing demographic information of a user of the wireless device.

9. The method of claim 1, wherein the advertising messages received from the advertisers are stored in a second database.

10. The method of claim 1, wherein at least a portion of air time costs for sending the advertising messages to the registered wireless device is paid for by the advertisers.

11. A system for wireless device advertising comprising:
a database comprising wireless device numbers for storing users of registered wireless devices;
a central processing unit coupled to the database, said central processing unit accessible by a network, and adapted to perform the functions of:
receiving an advertising message from an advertiser;
sending the advertising message to at least one of the registered wireless devices, wherein a user of the wireless device is remunerated for accepting the advertising message.

12. The system of claim 11, wherein the central processing unit is further adapted to perform the function of providing a user accessible account associated with each of the registered wireless devices that shows how much remuneration the account received for the associated wireless device accepting the advertising message.

13. The system of claim 11, wherein the central processing unit further provides means for users of wireless devices to register to receive advertising messages.

14. The system of claim 11, further comprising a second database of the advertising messages.

15. The system of claim 11, wherein the central processing unit further provides referral means for users of registered wireless devices to send messages to new users of wireless devices.

16. The system of claim 10, wherein costs for sending the advertising messages to the registered wireless device is paid for by the advertiser.

17. A method of using a computer network for wireless device advertising comprising:
providing a database containing a plurality of users of registered wireless devices and associated wireless device numbers;
receiving an advertising message from an advertiser over the computer network;
sending the advertising message to at least one of the wireless device numbers in the database; and
remunerating the at least one user for accepting the advertising message.

18. The method of claim 17 further comprising providing a user accessible account on the computer network for each of the registered wireless devices, wherein each user accessible account shows an amount of remuneration received for accepting advertising messages to the registered wireless devices.

19. The method of claim 17, wherein the remuneration is additional air time.

20. The method of claim 17 wherein the user accessible account for each of the registered wireless devices further shows an amount of remuneration for referring another user to register the another user's wireless device to accept advertising messages.

21. The method of claim 17, wherein at least a portion of air time costs for sending the advertising messages is paid for by the advertiser.

22. A method for wireless device advertising comprising:
providing advertising messages to a wireless advertising service that sends the messages to a plurality of wireless devices registered with the service; and
paying a fee to the wireless advertising service, wherein a portion of the fee goes to a user of the registered wireless device as remuneration for accepting the advertising messages.

23. The method of claim 22, wherein the advertising messages are text messages.

24. The method of claim 22, wherein the user is remunerated air time for accepting the advertising messages.

25. The method of claim 22, wherein the user is remunerated monetary compensation for accepting the advertising messages.

26. The method of claim 22, wherein the advertising message is a coupon.

27. The method of claim 22, wherein the advertising message is location based.

28. The method of claim 22, wherein at least a portion of air time costs for sending the advertising messages to the registered wireless device is paid for by said advertisers.

29. A method for wireless device advertising comprising:
sending advertising messages to a registered wireless device; and
providing remuneration to a user of the wireless device for accepting the advertising messages.

30. The method of claim 29, wherein the advertising messages are text messages.

31. The method of claim 29, wherein the user is remunerated air time for accepting the advertising messages.

32. The method of claim 29, wherein the user is remunerated monetary compensation for accepting the advertising messages.

33. The method of claim 29, wherein the advertising message is a coupon.

34. The method of claim 29, wherein the advertising message is location-based.

35. The method of claim 29, wherein the remuneration includes at least a portion of air time costs for sending the advertising messages to the registered wireless device.
